(19) United States
(12) Patent Application Publication
(10) Pub. No.: US 2004/0083899 A1
(43) Pub. Date: May 6, 2004

(54) Method and an apparatus for mixing two phases of a food product

(76) Inventor: Rolf Nilsson, Sodra Sandby (SE)

Correspondence Address: BURNS DOANE SWECKER & MATHIS L L P, POST OFFICE BOX 1404, ALEXANDRIA, VA, 22313-1404, US

(21) Appl. No.: 10/415,477

(22) PCT Filed: Oct. 29, 2001
(86) PCT No.: PCT/SE01/02367

(30) Foreign Application Priority Data
Oct. 30, 2000 (SE) 0003947-9

(51) Int. Cl. A23L 1/00

(52) U.S. Cl. 99/348

(57) ABSTRACT

The invention relates to a method and an apparatus for mixing two phases (2, 3) of a food product (1), where the first phase (2) constitutes the largest fraction of the product (1) and the second phase (3) constitutes the smallest fraction of the product (1). The second phase (3) is caused to pass a first distributor device (4) which is provided with a large number of holes (5). The second phase (3) is distributed out in the first phase (2) which surrounds the first distributor device (4) and which is enclosed in a first distributor housing (8). The first distributor housing (8) has an inlet (9) for the first phase (2), as well as an outlet (10) for the united phases (2, 3). The united phases (2, 3) are thereafter caused to pass at least a further second distributor device (13) which is provided with a large number of holes (14). A second distributor housing (16) surrounds the second distributor device (13). The second distributor housing (16) is provided with an outlet (17), through which the ready-mixed product (1) departs from the apparatus.

### FIELD OF THE INVENTION

The present invention relates to a method for mixing two phases of a food product, the first phase constituting the largest fraction of the product and the second phase constituting the smallest fraction of the product. The present invention also relates to an apparatus for carrying the method into effect.

### BACKGROUND OF THE INVENTION

Within the food industry, mixing different phases of a product often entails that there is one phase that constitutes a large proportion of the finished product and which, in many foods, consists of water or another low viscosity liquid. The other phase consequently then constitutes a minor proportion of the finished product and, for example, may be a concentrate of some kind.

Depending upon what the concentrate contains, it is more or less readily soluble in the liquid phase. Many fruit juice concentrates are relatively readily soluble because of their large content of fruit sugar. On the other hand, a number of vegetable concentrates, such as tomato concentrate, may be considerably more difficult to mix into the liquid phase, since they display a composition which results in the concentrate holding together to a large degree.

Regardless of what product the intention is to manufacture by mixing two phases of the product, the aim is to have a rapid and efficient mixing of the phases so that a homogeneous mixture will be obtained. Usually, this is realised in that concentrate and liquid are mixed in large tanks, horiiontal or vertical, which are provided with some form of agitator or paddle mechanism. In this case, the process will operate batchwise or possibly semi-continuously if it is possible to circulate the product across the mixing tanks. Employing large-Sized mixing tanks involves major costs, partly investment costs but also heavy costs for energy during operation. Large mixing tanks also take up a considerable amount of space. Washing such tanks also requires specific and complicated arrangements.

### SUMMARY OF THE INVENTION

One object of the present invention is to make it possible for a mixing process to be continuous or possibly semi-continuous.

A further object of the present invention is to realise an apparatus which is considerably more economical than the commonest prior art solutions today for mixing food products.

Yet a further object of the present invention is that the apparatus be easily to assemble, maintain and wash, and that the apparatus may readily be adapted to suit different food products.

These and other objects have been attained according to the present invention in that the method of the type disclosed by way of introduction has been given the characterising features that the second phase is caused to pass a first distributor device where it is divided out in the first phase which surrounds the distributor device, and that the admixed phases are thereafter caused to pass at least a second additional distributor device.

These and other objects have further been attained according to the present invention in that the apparatus of the type disclosed by way of introduction has been given the characterising feature that the apparatus includes a first distributor device, which is provided with a large number of holes and has an inlet for the second phase, as well as a first distributor housing which surrounds the first distributor device and which has an inlet for the first phase, as well as an outlet for the united phases, the apparatus also including at least one second distributor device which is provided with a large number of holes and which has an inlet for the united phases, as well as a second distributor housing which surrounds the second distributor device and which has an outlet for the product.

Preferred embodiments of the present invention have further been given the characterising features as set forth in the appended subclaims.

### BRIEF DESCRIPTION OF THE DRAWINGS

One preferred embodiment of the present invention will now be described in greater detail hereinbelow, with reference to the accompanying Drawings, in which:

FIG. 1 shows an apparatus according to the present invention; and

FIG. 2 shows a semi-continuous embodiment of the apparatus according to the present invention.

The accompanying Drawings show only those parts and details essential to an understanding of the present invention, and the location of the apparatus in a complete processing plant, which is well-known to a person skilled in the art, has been omitted.

### DETAILED DESCRIPTION OF THE INVENTION

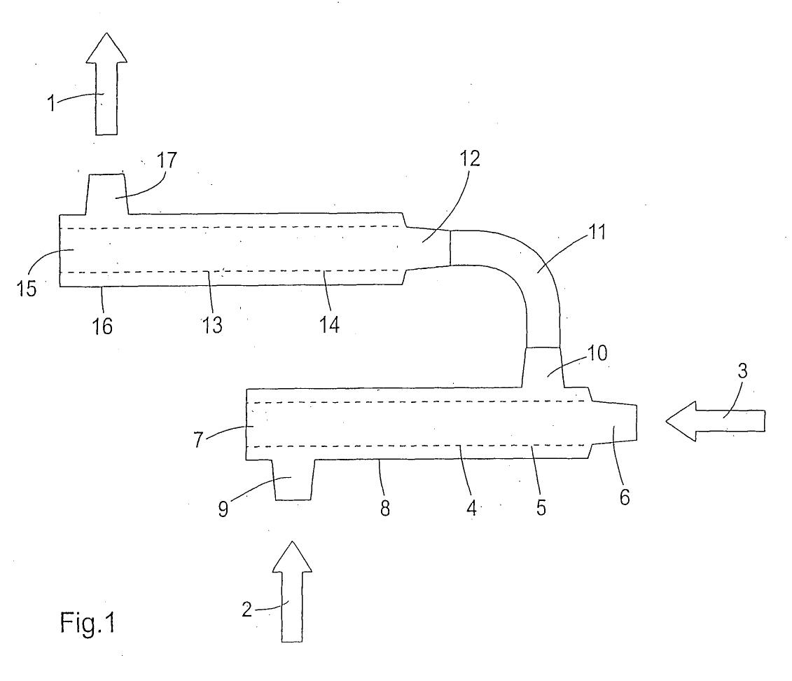

The apparatus (see FIG. 1) and the method according to the present invention are intended for mixing a food product 1 which consists of two phases 2 and 3. The first phase 2 constitutes the largest fraction of the product 1 and the second phase 3 constitutes the smallest fraction of the product 1.

FIG. 1 shows an apparatus according to the present invention. The apparatus includes a first distributor device 4 which, in its simplest version, may consist of a filter insert. In the preferred embodiment, the distributor device 4 is of circular cross section and is provided with a large number of holes 5. The size of the holes is adapted to that product 1 which is to be treated and is, in the preferred embodiment, 0.2-3 mm.

The length of the distributor device 4 depends on the capacity of the apparatus and on how large a proportion the second phase 3 makes up of the finished product 1. If a simple filter insert is selected, this has a standard length of approx. 0.5 m.

The distributor device 4 is suitably manufactured from stainless steel which has high durability arid may efficiently be washed using conventional washing equipment, a so-called CIP unit (Cleaning In Place). Alternatively, other materials such as food-approved plastics may be employed.

The first distributor device 4 is provided with an inlet 6 for the second phase 3 of the food product 1. The inlet 6 constitutes, in the preferred embodiment, an extension of the one end of the distributor device 4. Other positioning of the inlet 6 are also conceivable. The other end 7 of the distributor device 4 close tightly against a first distributor housing 8 which wholly surrounds the distributor device 4. In the preferred embodiment, the distributor housing 8 is of circular cross section and may, in its simplest embodiment, consist of a housing for a filter insert. The distributor housing 8 is suitably manufactured from stainless steel but other materials, such as food-approved plastics, may be employed.

In the preferred embodiment, the first distributor housing 8 has, in its one end, an inlet 9 for the first phase 2 of the food product. In its other end, the distributor housing 8 has an outlet 10 for the united phases 2 and 3 of the product. Other positionings of both inlet 9 and outlet 10 are also conceivable.

With a short pipe length or pipe bend 11, the outlet 10 from the first distributor housing 8 connects to an inlet 12 on a second distributor device 13 which, in its simplest version, may consist of a filter insert. In the preferred embodiment, the distributor device 13 is of circular cross section and it is provided with a large number of holes 14. The size of the holes 14 is adapted to the product 1 which is to be mixed and is, in the preferred embodiment, 2-5 mm. The second distributor device 13 is of a length and of a material which correspond to the first distributor device 4.

In the preferred embodiment, the inlet 12 constitutes an extension of the one end of the second distributor device 13. Other positionings of the inlet 12 are also conceivable. The other end 15 of the distributor device 13 closes tightly against a second distributor housing 16 which wholly surrounds the distributor device 13. The distributor housing 16 is, in the preferred embodiment, of circular cross section and may, in its simplest version, consist of a housing for a filter insert. The second distributor housing 16 is manufactured from a material which corresponds to the material of the first distributor housing 8. In the preferred embodiment, the second distributor housing 13 has, in its one end, an outlet 17 for the intermixed product 1. Alternative positionings of the outlet 17 are conceivable.

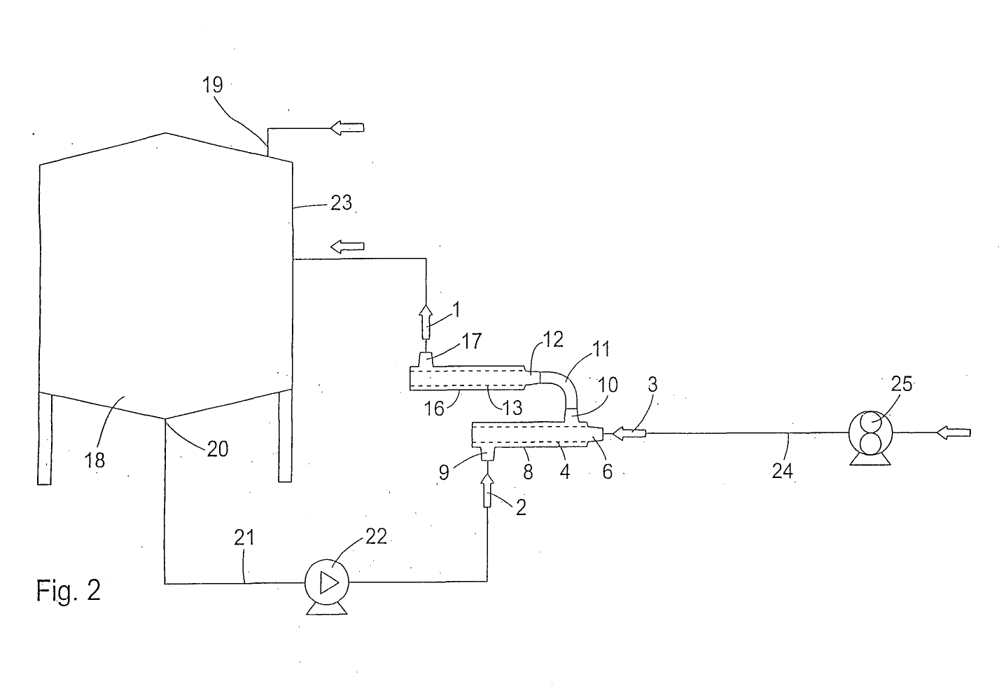

FIG. 2 shows an apparatus according to the present invention which is employed in a semi-continuous process. This embodiment may be employed for particularly sensitive products which require longer time and more measures to be implemented to be mixed in a satisfactory and efficient manner. An alternative to this semi-continuous embodiment is that the apparatus according to the present invention be supplemented with a third distributor device with a third distributor housing which has the same construction as the second distributor device and second distributor housing.

In that case when it is selected to have a third distributor device, a wholly ready-mixed product 1 may be obtained after the third distributor device. In order to obtain a correct admixture of the two phases 2 and 3, the plant must be supplemented with flow metering and control of the flow through the apparatus.

The embodiment which is shown in FIG. 2 consists, in addition to the apparatus according to the present invention, of a mixing tank 18. The mixing tank 18 has, in its upper region, an inlet for water 19. The water conduit into the tank 18 should suitably be provided with some form of metering equipment in order that the exact quantity of water can be supplied. In its lower region, the mixing tank 18 has an outlet 20 for product and a conduit 21 for the product, suitably provided with a pressurising pump 22. The mixing tank 18 finally has an inlet 23 for the united phases 2 and 3, or alternatively product 1 depending upon how many times the united phases 2 and 3 have been caused to pass through the apparatus according to the invention.

The second phase 3 which, for example may consist of tomato concentrate, enters into the apparatus in FIG. 2 through the conduit 24. A pressurising pump 25 is disposed on the conduit 24. The pump 25 should suitably be a positive displacement pump such as a lobe rotor pump, since concentrates of fruit or vegetables are often highly viscous. Some form of control of the quantity of concentrate should also take place on infeed of the second phase 3. In its simplest form, such control may be a certain number of barrels of a specific concentrate, or consist of more automated measurement equipment.

The second phase 3 is pumped into the apparatus and enters into the first distributor device 4 through the inlet 6. At the same time, the first phase 2 (which may, for example, consist of water) is pumped into the first distributor housing 8 through the inlet 9. The second phase 3 is injected into the first phase 2 and both of the united phases 2 and 3 are fed via the outlet 10 and the conduit 11 into the second distributor device 13 through the inlet 12. When the united phases 2 and 3 pass the holes 14 of the second distributor device 13, the phases 2 and 3 will be mixed further. This mixture is fed on into the tank 18 through the inlet 23 and this cycle is repeated until a sufficiently homogeneous mixture of the product 1 is obtained. Through a branch of the conduit 21 after the pump 22, the now ready-mixed product is fed further to possible heat treatment and further to packing of the product 1 in consumer packages.

The method according to the present invention and the apparatus for carrying it into effect may be employed for a number of practical applications such as the dilution of fruit or vegetable concentrate or the like. If the concentrate contains fibres, these should be of limited length in order to avoid the risk that fibres “suspend” themselves between the holes 5 and 14 in the distributor devices 4 and 13, respectively.

The apparatus may also be employed for adding milk fat to recombined milk., i.e. milk that has been produced from milk powder and water. The apparatus may also be employed for an application in which the intention is merely to add a minor quantity of liquid to a concentrate. In this case, the first phase 2 consists of the concentrate which is then the largest fraction and the second phase 3 will be the liquid which is only added to a lesser degree. The apparatus may be adapted for both end products and various intermediate products which are to be treated further or refined in a later process.

The product 1 which is to be mixed determines the hole size in the two distributor devices 4 and 13. For example, for tomato juice production, use may be made of a hole size of 2 mm for the first distributor device 4 and a hole size of 3 mm for the second distributor device 13.

In that case where the intention is to add liquid milk fat to a recombined milk, use may suitably be made of a hole size of 0.5 mm for the first distributor device 4 and 2 mm for the second distributor device 13. The design of the apparatus makes for simple replacement of the distributor devices 4 and 13 in both or one of the distributor housings 8 and 16.

As will have been apparent from the foregoing description, the present invention realises a method and an apparatus for mixing two phases of a food product in a simple and efficient manner. The apparatus is easy to position in place, since it requires but limited space and is more economical since it does not require expensive mixing tanks with complex agitation equipment

What is claimed is:

1. A method for mixing two phases (2, 3) of a food product (1), the first phase (2) constituting the largest fraction of the product (1) and a second phase (3) constituting the smallest fraction of the product (1), characterised in that the second phase (3) is caused to pass a first distributor device (4) where it is distributed out into the first phase (2) which surrounds the distributor device (4), and that the united phases (2, 3) are thereafter caused to pass through at least a further second distributor device (13).

2. The method as claimed in claim 1, characterised in that the united phases (2, 3) are caused to pass a third distributor device, and that the device includes means for flow metering and flow control.

3. The method as claimed in claim 1, characterised in that the apparatus includes a mixing tank (18) and the united phases (2, 3) are caused to pass the apparatus and the mixing tank (18) repeatedly.

4. An apparatus for mixing two phases (2, 3) of a food product (1), where the first phase (2) constitutes the largest fraction of the product (1) and a second phase (3) constitutes the smallest fraction of the product (1), characterised in that the apparatus includes a first distributor device (4) which is provided with a large number of holes (5) and which has an inlet (6) for the second phase (3), as well as a first distributor housing (8) which surrounds the first distributor device (4) and which has an inlet (9) for the first phase (2), as well as an outlet (10) for the united phases (2, 3), the apparatus further including at least a second distributor device (13) which is provided with a large number of holes (14) and which has an inlet (12) for the united phases (2, 3), as well as a second distributor housing (16) which surrounds the second distributor device (13) and which has an outlet (17) for the product (1).

5. The apparatus as claimed in claim 4, characterised in that the holes (5) in the first distributor device (4) are of a size of the order of magnitude of 0.2-3 mm, and that the holes (14) in the second distributor device (13) are of a size of the order of magnitude of 2-5 mm.
